(19) United States
(12) Patent Application Publication
(10) Pub. No.: US 2013/0194570 A1
(43) Pub. Date: Aug. 1, 2013

(54) APPARATUS FOR PERFORMING SPECTROSCOPY

(71) Applicants: Wei WU, Palo Alto, CA (US); Michael Josef Stuke, Palo Alto, CA (US); Zhiyong Li, Foster City, CA (US); James Elmer Abbott, JR., Albany, OR (US); Min Hu, Sunnyvale, CA (US); Ansoon Kim, Mountain View, CA (US)

(72) Inventors: Wei WU, Palo Alto, CA (US); Michael Josef Stuke, Palo Alto, CA (US); Zhiyong Li, Foster City, CA (US); James Elmer Abbott, JR., Albany, OR (US); Min Hu, Sunnyvale, CA (US); Ansoon Kim, Mountain View, CA (US)

(21) Appl. No.: 13/363,006

(22) Filed: Jan. 31, 2012

(51) Int. Cl. G01J 3/44; G01J 3/28

(52) U.S. Cl. 356/301; 356/300

(57) ABSTRACT

An apparatus for performing spectroscopy includes an optical waveguide comprising a fluidic channel to receive a fluid sample, in which the optical waveguide is to propagate lightwaves at a set of frequencies. The apparatus also includes a wavelength selective device coupled to the optical waveguide, in which the wavelength selective device comprises a predetermined bandwidth and is to capture frequencies of light within the predetermined bandwidth. The apparatus further includes a detector coupled to the wavelength selective device to generate signals that identify the frequencies captured by the wavelength selective device.

### RELATED APPLICATION

This application shares some common subject matter with U.S. Patent Application Publication No. 2011/0267610, titled “Compact Sensor System”, published on Nov. 3, 2011.

### BACKGROUND

Raman spectroscopy has been utilized for a number of years to analyze the structure of inorganic materials and complex organic molecules. It has been found that by decorating a surface, upon which a molecule is later adsorbed, with a thin layer of a metal in which surface plasmons have frequencies in a range of electromagnetic radiation used to excite such a molecule and in which surface plasmons have frequencies in a range of electromagnetic radiation emitted by such a molecule, the intensity of a Raman spectrum of such a molecule may be enhanced. This technique has been termed surface enhanced Raman spectroscopy (SERS). The SERS effect is related to the phenomenon of plasmon resonance, in which metal nanoparticles exhibit an increased optical resonance in response to incident electromagnetic radiation, due to the collective coupling of conduction electrons in the metal.

### BRIEF DESCRIPTION OF THE DRAWINGS

Features of the present disclosure are illustrated by way of example and not limited in the following figure(s), in which like numerals indicate like elements, in which:

FIG. 1A shows a side view of an apparatus for performing spectroscopy, according to an example of the present disclosure;

FIG. 1B shows a side view of an apparatus for performing spectroscopy, according to another example of the present disclosure;

FIG. 1C shows a cross-sectional side view of a portion of the apparatus depicted in FIG. 1A, according to an example of the present disclosure;

FIGS. 2A and 2B, respectively, show enlarged, cross-sectional views of a portion of the nano-fingers depicted in FIG. 1C, according to an example of the present disclosure; and

FIG. 3 shows a flow diagram of a method for performing spectroscopy, according to an example of the present disclosure.

### DETAILED DESCRIPTION

For simplicity and illustrative purposes, the present disclosure is described by referring mainly to an example thereof. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure.

Throughout the present disclosure, the terms “a” and “an” are intended to denote at least one of a particular element. As used herein, the term “includes” means includes but not limited to, the term “including” means including but not limited to. The term “based on” means based at least in part on. In addition, the term “light” refers to electromagnetic radiation with wavelengths in the visible and non-visible portions of the electromagnetic spectrum, including infrared and ultra-violet portions of the electromagnetic spectrum.

Disclosed herein are an apparatus and a method for performing spectroscopy. The apparatus includes an optical waveguide having a fluidic channel, a wavelength selective device coupled to the optical waveguide, and a detector coupled to the wavelength selective device. As discussed in greater detail below, a fluid sample is to be supplied into the fluidic channel and an excitation light is to illuminate the fluid sample. The molecules in the fluid sample are to emit a Raman scattered light in response to becoming illuminated by the excitation light. In certain examples, the emission of the Raman scattered light is enhanced by nano-fingers and Raman-active nano-particles provide in the fluidic channel.

The wavelengths and frequencies of the Raman scattered light generally depend upon the type(s) of molecules contained in the fluid sample. In this regard, the wavelengths and frequencies of the Raman scattered light emitted from the molecules in the fluid sample are detected to determine, for instance, the type(s) of molecules contained in the fluid sample. More particularly, a wavelength selective device is coupled to the optical waveguide, in which the wavelength selective device comprises a predetermined bandwidth and is to capture wavelengths and frequencies of light within the predetermined bandwidth. In other words, the wavelength selective device is to be resonant to specific light wavelengths and frequencies. The wavelength selective device, therefore, enables lightwaves having a predetermined frequency and wavelength to propagate from the optical waveguide through the wavelength selective device and onto a detector coupled to the wavelength selective device.

According to an example, each of a plurality of the wavelength selective devices is tuned to be resonant with a particular frequency and wavelength. In this example, the apparatus may be provided with wavelength selective devices that are each tuned to detect a predetermined frequency, such that, if each of the detectors coupled to the wavelength selective devices detects light, then a particular type of molecule may be determined to be present in the fluid sample. Alternatively, the apparatus may be provided with a plurality of wavelength selective devices that are tuned to detect a wide range of frequencies, such that, a determination of which of the detectors coupled to the wavelength selective devices detect light, maybe need to determine the type of molecules contained in the fluid sample.

According to another example, the wavelength selective device(s) comprises a tunable device, in which, the wavelength selective device(s) is tunable to be resonant with different frequencies of light. In this example, the wavelength selective device(s) may be tuned to be resonant with different frequencies of light to determine the frequencies at which light is emitted from the fluid sample. The frequencies of the emitted light that the detectors detect may be analyzed to determine the type of molecules contained in the fluid sample.

Through implementation of the apparatus and method disclosed herein, the type(s) of molecules contained in a fluid sample is to be determined through a determination of the frequencies and wavelengths of light detected to be emitted from the molecules of the fluid sample. In addition, the components of the apparatus may be integrated onto a single chip, such that, the apparatus comprises a relatively small and compact form factor.

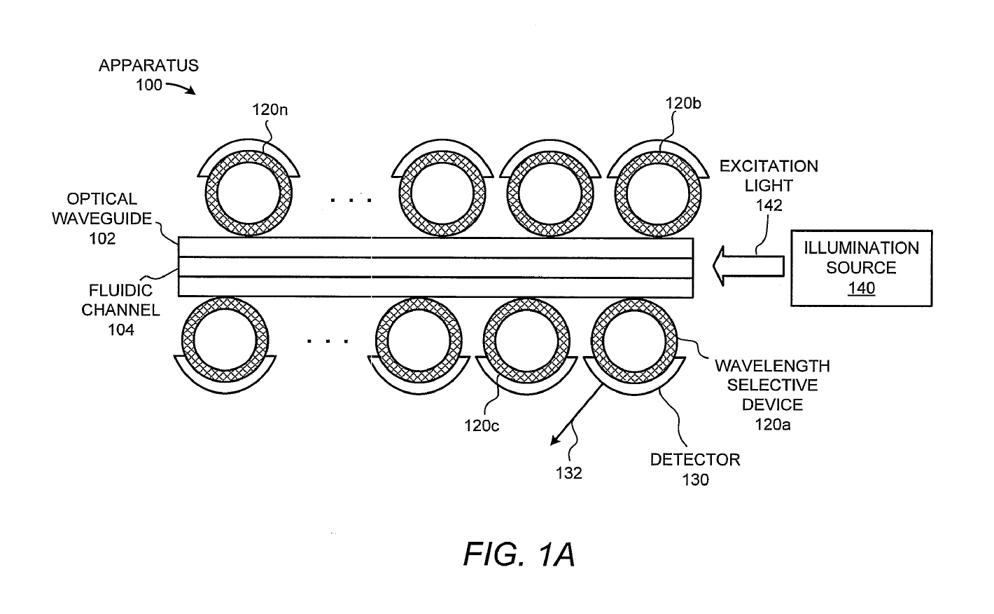

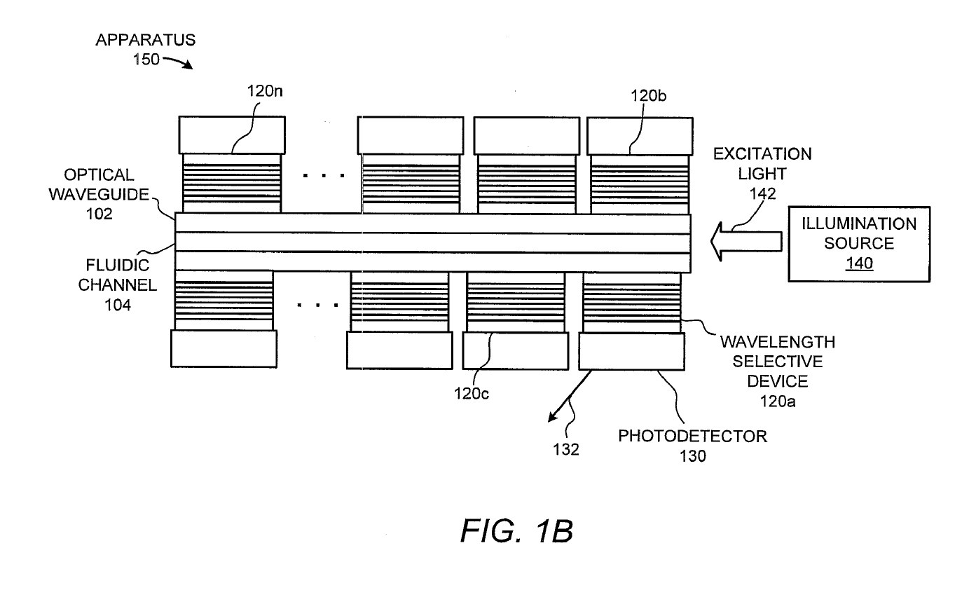

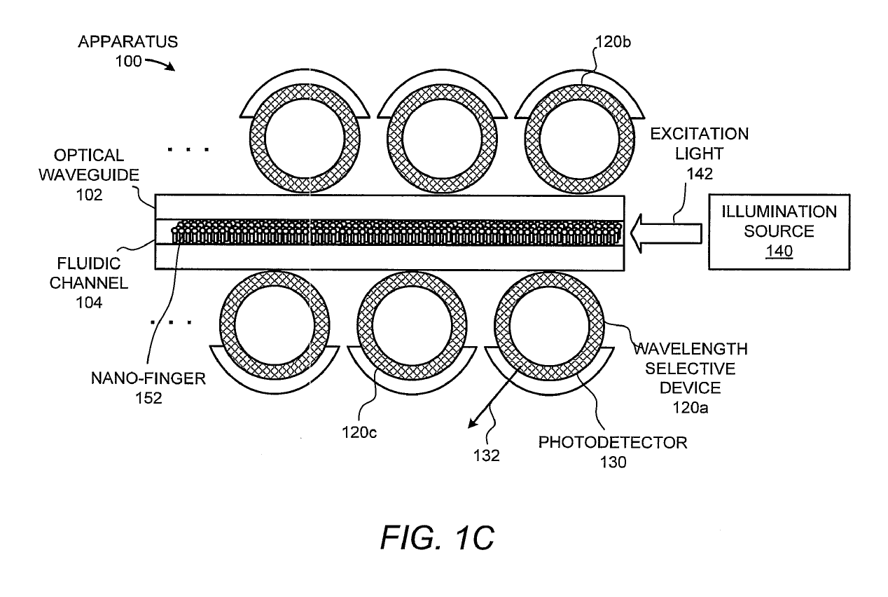

FIG. 1A shows a side view of an apparatus 100 for performing spectroscopy, according to an example. It should be understood that the apparatus 100 depicted in FIG. 1A may include additional components and that some of the components described herein may be removed and/or modified without departing from a scope of the apparatus 100. It should also be understood that the components depicted in FIG. 1A are not drawn to scale and thus, the components may have different relative sizes with respect to each other than as shown therein.

The apparatus 100 is implemented to perform SERS to detect a molecule in an analyte sample with a relatively high level of sensitivity. The apparatus 100 includes an optical waveguide 102, which includes a fluidic channel 104. As shown in FIG. 1A, the fluidic channel 104 is formed within the optical waveguide 102 and generally comprises an opening through the optical waveguide 102 through which a fluid is to be introduced and may flow. The optical waveguide 102 is a structure that is to guide electromagnetic waves in the optical spectrum. In this regard, the optical waveguide 102 may be formed of an optically transparent material, such as, glass, plastic, polymer, etc. The optical waveguide 102 and the fluidic channel 104 may comprise any suitable cross-sectional shape, such as, circular, rectangular, square, hexagonal, etc. In addition, the fluidic channel 104 may comprise the same or a different cross-sectional shape as compared with the optical waveguide 102.

The illumination source 140 comprises any suitable type of light source to direct excitation light 142 onto a sample contained in the fluid channel 104 and to cause Raman scattered light to be emitted from the sample. The illumination source 140 may thus comprises a solid state laser, such as, a plasmonic laser, a cavity laser, etc. In addition, or alternatively, the optical range of the excitation light 142 may vary from ultraviolet to infrared. The illumination source 140 is to supply the excitation light 142 to the optical waveguide 102 over free space or directly, for instance, through an optical fiber (not shown).

In any regard, and as discussed in greater detail herein below, the excitation light 142 is to illuminate the molecules of a fluid sample (not shown) contained in the fluidic channel 104. The illuminated molecules of the fluid sample is to emit light, such as, Raman, fluorescence, etc., at a set of frequencies depending upon the molecules contained in the fluid sample. The light emitted from the molecules of the fluid sample may undergo an elastic or inelastic scattering process, which may be directly analyzed as discussed below. Moreover, the optical waveguide 102 is to propagate light at the set of frequencies emitted from the molecules of the fluid sample through the optical waveguide 102.

The optical waveguide 102 is also depicted as being coupled with a plurality of wavelength selective devices 120a-120n, in which the term “n” comprises an integer equal to or greater than one. The wavelength selective devices 120a-120n may be coupled to the optical waveguide 102 in any suitable manner. For instance, the optical waveguide 102 may be provided with integration sites (not shown) at which the wavelength selective devices 120a-120n are coupled to the optical waveguide 102. In addition, or alternatively, the wavelength selective devices 120a-120n are coupled to the optical waveguide 102 through waveguide connectors (not shown) that are to propagate luminescence therethrough. The waveguide connectors may be fabricated out of the same material as the optical waveguide 102.

Generally speaking, the wavelength selective devices 120a-120n operate as filters that selectively capture specific wavelengths of light. In other words, the wavelength specific devices 120a-120n are resonant with particular frequencies and wavelengths of light. As such, light having the particular frequencies and wavelengths of light are able to propagate through the wavelength specific devices 120a-120n, while light having other frequencies and wavelengths do not resonate in the wavelength specific devices 120a-120n. In this regard, as light travels through the optical waveguide 102, the wavelength selective devices 120a-120n may each respectively tune out those frequencies and wavelengths of light that are not resonant with the wavelength selective devices 120a-120n. As such, none of the detectors 130 will detect the lightwaves that are not resonant with any of the wavelength selective devices 120a-120n.

In a first example, each of the wavelength selective devices 120a-120n is tuned to selectively capture a different wavelength or range of wavelengths of light. In this example, the wavelength selective devices 120a-120n comprise different predetermined bandwidths and are to capture the set of frequencies from the luminescence corresponding to frequencies within the predetermined bandwidths. For example, a first wavelength selective device 120a may be tuned to comprise a bandwidth including a frequency of 785 nanometers. In this example, the first wavelength selective device 120a would capture the photons of the luminescence that are propagated through the optical waveguide 102 that include a frequency of 785 nanometers.

Examples of other bands of frequency that may be provided by the molecules of the fluid sample during spectroscopy include but are not limited to the following: 415 nanometers, 572 nanometers, 673 nanometers, 785 nanometers and 1064 nanometers. The wavelength selective devices 120a-120n may be tuned to a relatively narrow bandwidth, and thus, a relatively narrow range of frequencies. Furthermore, in one example, several wavelength selective devices 120a-120n may be finely tuned to cover a small range of wavelengths. The bandwidths of these same wavelength selective devices 120a-120n may be overlapped, thus covering a continuous wavelength band.

In a second example, the wavelength selective devices 120a-120n comprise tunable wavelength selective devices, in which, the wavelength selective devices 120a-120n are tunable to selectively capture different wavelengths or ranges of wavelengths of light. In a third example, the wavelength selective devices 120a-120n comprise a combination of tuned and tunable wavelength selective devices.

As also shown in FIG. 1A, each of the wavelength selective devices 120a-120n is coupled to a respective detector 130. The wavelength selective devices 120a-120n may be coupled to the detectors 130 in any suitable manner. For instance, the wavelength selective devices 120a-120n may be coupled to the detectors 130 through respective waveguide connectors (not shown), that are to propagate luminescence therethrough. The waveguide connectors may be fabricated of the same material as the optical waveguide 102.

The detectors 130 may be sensitive to a relatively large band of frequencies. Alternatively, the detectors 130 may be tuned to a certain band of frequencies, for instance, the frequencies of light that are to be emitted through the respective wavelength selective devices 120a-120n. In any regard, the detectors 130 are to generate electrical signals 132, which may be processed to determine each of the set of frequencies of the luminescence captured by the wavelength selective devices 120a-120n.

According to an example, the wavelength selective devices 120a-120n comprise ring resonators, as shown in FIG. 1A. The ring resonators 120a-120n generally comprise waveguides in a closed loop that, when light of the appropriate wavelength is coupled to the loop from the optical waveguide 102, the light builds up in intensity over multiple round-trips due to constructive interference. The light may then be picked up by a detector 130. In one regard, the ring resonators may be tuned to a relatively narrow bandwidth, and thus, a relatively narrow range of frequencies. Furthermore, in one example, several ring resonators may be finely tuned to cover a small range of wavelengths. The bandwidths of these same ring resonators may be overlapped, thus covering a continuous wavelength band.

As discussed above, each of the wavelength selective devices 120a-120n may be tuned to a particular frequency or wavelength or may be tunable. In instances where the wavelength selective devices 120a-120n are tunable, the ring resonators may be tuned through any suitable tuning operation. For instance, the ring resonators may be tuned through application of different levels of heat to the ring resonators, application of different charge injections, application of different electro-optical effects, etc. In addition, although the ring resonators 120a-120n have been depicted as comprising circular shapes, the ring resonators may be fabricated in different shapes, such as, an oval shape.

In other examples, the wavelength selective devices 120a-120n comprise other types of wavelength selective devices, such as, distributed Bragg reflectors (DBRs), Fabry-Perot interferometers, etc. An example of an apparatus 150 comprising DBRs as the wavelength selective devices 120a-120n is depicted in FIG. 1B. As shown in FIG. 1B, the apparatus 150 includes all of the same elements as those depicted in the apparatus 100 depicted in FIG. 1A. As such, the elements having the same reference numerals are not described again with respect to FIG. 1B. In addition, other examples include a combination of different types of wavelength selective devices 120a-120n, such as, a combination of ring resonators and DBRs.

In one example, each of the wavelength selective devices 120a-120n comprises a DBR that is tuned to enable selected frequencies or wavelengths of light to reach the respective detectors 130. In another example, each of the wavelength selective devices 120a-120n comprises a tunable DBR that is tunable to selectively vary the frequency and the wavelength of light that is able to propagate through the wavelength selective devices 120a-120n and onto respective detectors 130. In this example, the DBRs (wavelength selective devices) 120a-120n may be tuned through any suitable tuning operation. For instance, the DBRs (wavelength selective devices) 120a-120n may be tuned through application of electricity onto the DBRs, etc.

Turning now to FIG. 1C, there is shown a cross-sectional side view of a portion of the apparatus 100 depicted in FIG. 1A, according to an example. The additional elements depicted in FIG. 1C may also be provided in the apparatus 150 depicted in FIG. 1B. As shown in FIG. 1C, the fluidic channel 104 is depicted as including a plurality of nano-fingers 152 over which a fluid sample is to be provided. In one example, the nano-fingers 152 are attached at first ends thereof to the optical waveguide 102, with second ends thereof being relatively freely movable with respect to each other. In this example, the nano-fingers 152 may be integrally formed with the optical waveguide 102 and the fluid channel 104. In another example, the nano-fingers 152 are attached to or formed onto a separate substrate (not shown) and are subsequently inserted into the fluidic channel 104.

In any regard, the nano-fingers 152 may be attached to a surface of the optical waveguide 102 or separate substrate through any suitable attachment mechanism. For instance, the nano-fingers 152 may be grown directly on the optical waveguide 102 or separate substrate surface through use of various suitable nano-structure growing techniques. As another example, the nano-fingers 152 may be integrally formed with the optical waveguide 102 or separate substrate. In this example, for instance, a portion of the material from which the optical waveguide 102 or substrate is fabricated and may be etched or otherwise processed to form the nano-fingers 152. In a further example, a separate layer of material may be adhered to the optical waveguide 102 or separate substrate surface and the separate layer of material may be etched or otherwise processed to form the nano-fingers 152.

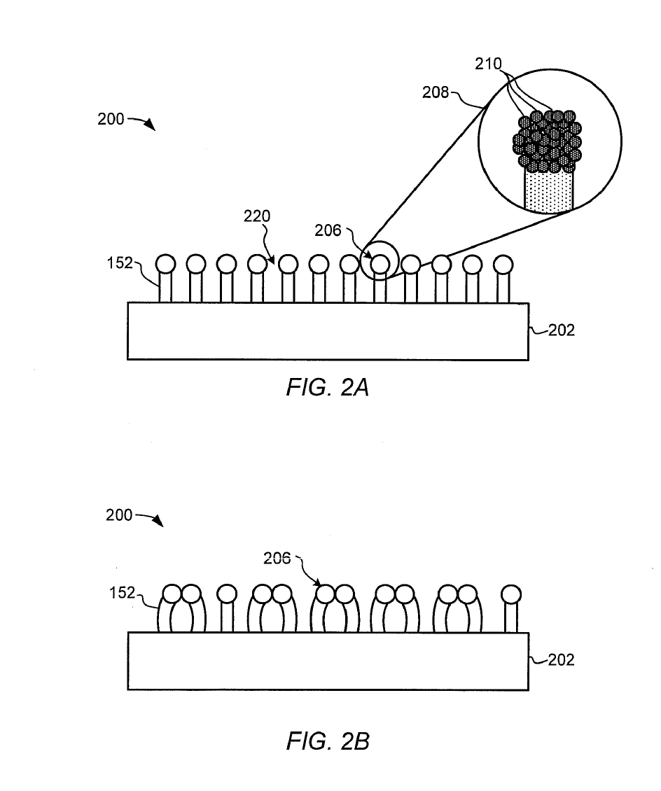

Turning now to FIG. 2A, there is shown an enlarged, cross-sectional view of a portion 200 of the nano-fingers 152 depicted in FIG. 1C, in accordance with an example. In the portion 200, the nano-fingers 152 are depicted as being attached to a substrate 202, which may comprise a portion of the optical waveguide 102 and/or a separate substrate that may be inserted into the fluidic channel 104 of the optical waveguide 102.

In any of the examples above, the nano-fingers 152 are formed of a relatively flexible material to enable the nano-fingers 152 to be laterally bendable, for instance, to enable free ends 206 of the nano-fingers 152 to move toward each other, as discussed in greater detail herein below. Examples of suitable materials for the nano-fingers 152 include polymer materials, such as, UV-curable or thermal curable imprinting resist, polyalkylacrylate, polysiloxane, polydimethylsiloxane (PDMS) elastomer, polyimide, polyethylene, polypropelene, fluoropolymer, etc., or any combination thereof, metallic materials, such as, gold, silver, aluminum, etc., semiconductor materials, etc., and combinations thereof. In various examples, the nano-fingers 152 may be fabricated through a nanoimprinting process in which a template of relatively rigid pillars is employed in a multi-step imprinting process on a polymer matrix to form the nano-fingers 152. Various other processes, such as, etching, and various techniques used in the fabrication of micro-electromechanical systems (MEMS) and nano-electromechanical systems (NEMS) may also be used to fabricate the nano-fingers 152.

A nano-finger 152 may be defined as an elongated, nanoscale structure having a length (or height) that exceeds by more than several times a nanoscale cross sectional dimension (for instance, width) taken in a plane perpendicular to the length (for instance, length>3×width). In general, the length is much greater than the width or cross sectional dimension to facilitate bending of the nano-finger 152 laterally onto one or more neighboring nano-fingers 152. In some examples, the length exceeds the cross sectional dimension (or width) by more than a factor of about 5 or 10. For example, the width may be about 100 nanometers (nm) and the height may be about 500 nm. In another example, the width at the base of the nano-finger 152 may range between about 20 nm and about 300 nm and the length may be more than about 1 micrometer (μm). In other examples, the nano-finger 152 is sized based upon the types of materials used to form the nano-finger 152. Thus, for instance, the more rigid the material(s) used to form the nano-finger 152, the less the width of the nano-finger 152 may be to enable the nano-finger 152 to be laterally collapsible. In further examples, the nano-fingers 152 may form ridges in which two of three dimensions (for instance length and height) exceed by more than several times a nanoscale cross sectional dimension (for instance, width).

As shown in FIG. 1C, the nano-fingers 152 are arranged in an array. The array may include a substantially random distribution of nano-fingers 152 or a predetermined configuration of nano-fingers 152. In any regard, and as discussed in greater detail herein below, the nano-fingers 152 are arranged with respect to each other such that the free ends 206 of at least two neighboring nano-fingers 152 are able to touch each other when the nano-fingers 152 are in a bent condition. By way of particular example, the neighboring nano-fingers 152 are positioned less than about 100 nanometers apart from each other. In addition, the array may include any number of nano-fingers 152 in each row without departing from a scope of the apparatus 100. In one regard, the apparatus 100 may include a relatively large number of nano-fingers 152.

The nano-fingers 152 have been depicted in FIGS. 1C and 2A as having substantially cylindrical cross-sections. It should, however, be understood that the nano-fingers 152 may have other shaped cross-sections, such as, for instance, rectangular, square, triangular, etc. In addition, or alternatively, the nano-fingers 152 may be formed with one or more features, such as, notches, bulges, etc., to substantially cause the nano-fingers 152 to be inclined to bend in a particular direction. Thus, for instance, two or more adjacent nano-fingers 152 may include the one or more features to increase the likelihood of the free ends 206 of these nano-fingers 152 to bend toward each other.

In addition, in FIG. 2B, a free end 206 of a nano-finger 152 is magnified in an enlargement 208, which reveals that the nano-finger 152 includes Raman-active material nano-particles 210 disposed on the outer surface, near the tip or free end 206, of the nano-finger 152. The other nano-fingers 152 may also include the Raman-active material nano-particles 210 as represented by the circles on the tops or free ends of the nano-fingers 152. Although the enlargement 208 depicts the Raman-active material nano-particles 210 as covering the entire tip of the nano-finger 152, it should be understood that examples of the apparatus 100 may be implemented with gaps between some of the Raman-active material nano-particles 210. It should also be noted that examples of the apparatus 100 are not limited to Raman-active material nano-particles 210 disposed over just the tips of the nano-fingers 152. In other examples, the Raman-active material nano-particles 210 may be disposed over part of or nearly the entire surface of the nano-fingers 152.

In any regard, the Raman-active material nano-particles 210 may be deposited onto at least the free ends of the nano-fingers 152 through, for instance, physical vapor deposition (PVD), chemical vapor deposition (CVD), sputtering, etc., of metallic material, or self-assembly of pre-synthesized nano-particles. By way of example, the angle at which the Raman-active material nano-particles 210 are deposited onto the free second ends of the nano-fingers 152 may be controlled to thereby substantially control the deposition of the nano-particles 210.

In addition, the Raman-active material nano-particles 210 may one or both of enhance Raman scattering and facilitate analyte adsorption. The Raman-active material nano-particles 210 generally enhance sensing operations, such as, surface enhanced Raman spectroscopy (SERS), enhanced fluorescence, enhanced luminescence, etc., to be performed on particles positioned on or near the nano-fingers 152. The sensing operations are performed on the particles to detect molecules in fluid samples. The Raman-active material nano-particles 210 may comprise a Raman-active material such as, but not limited to, gold (Au), silver (Ag), and copper (Cu) having nanoscale surface roughness. Nanoscale surface roughness is generally characterized by nanoscale surface features on the surface of the layer(s) and may be produced spontaneously during deposition of the Raman-active material layer(s). By definition herein, a Raman-active material is a material that facilitates Raman scattering and the production or emission of the Raman signal from an analyte adsorbed on or in a surface layer or the material during Raman spectroscopy.

In some examples, surfaces of the nano-fingers 152 may be functionalized to facilitate adsorption of an analyte. For example, the tips or free ends of the nano-fingers 152 in a vicinity thereof (not illustrated) may be functionalized with a binding group to facilitate binding with a specific target analyte species. A surface of the Raman-active material nano-particles 210 may be functionalized, for example. The functionalized surface (that is, either a surface of the nano-finger 152 itself and/or the Raman-active material nano-particles 210) may provide a surface to which a particular class of analytes is attracted and may bond or be preferentially adsorbed. The functionalized surface may selectively bond with protein, DNA or RNA, for example.

Although the nano-fingers 152 have been depicted as each extending vertically and at the same heights with respect to each other, it should be understood that some or all of the nano-fingers 152 may extend at various angles and heights with respect to each other. The differences in angles and/or heights between the nano-fingers 152 may be based upon, for instance, differences arising from manufacturing and/or growth variances existent in the fabrication of the nano-fingers 152 and the deposition of the Raman-active material nano-particles 210 on the nano-fingers 152, etc.

As shown in FIG. 2A, the nano-fingers 152 are in a first position, in which the free ends 206 are in a substantially spaced arrangement with respect to each other. Gaps 220 between the free ends 206 may be of sufficiently large size to enable analyte or other liquid to be delivered in the gaps 220. In addition, the gaps 220 may be of sufficiently small size to enable the free ends 206 of at least some of the nano-fingers 152 to move toward each other as the analyte or other liquid evaporates, through, for instance, capillary forces applied on the free ends 206 as the analyte or other liquid dries.

Turning now to FIG. 2B, there is shown a cross-sectional view of the portion 200 of the nano-fingers 152 depicted in FIGS. 1C and 2A, in a collapsed state, in accordance with an example. As shown in FIG. 2B, the free ends 206 of some of the nano-fingers 152 are in substantial contact with each other. According to an example, the free ends 206 of some of the nano-fingers 152 may be in and may remain in substantial contact with each other for a period of time due to the capillary forces applied on the free ends 206 during and following evaporation of a liquid in the gaps 220 between the free ends 206. In other examples, the free ends 206 of some of the nano-fingers 104 may be maintained in the second positions through, for instance, removal of an electrostatic charge on the free ends 206. In these examples, the nano-fingers 152 may be fabricated to normally have the second position depicted in FIG. 2B and may have the first position depicted in FIG. 2A when the electrostatic charge is applied onto the free ends 206 of the nano-fingers 152.

In any event, and in one regard, the free ends 206 of the nano-fingers 152 may be caused to contact each other as shown in FIG. 2B to cause an analyte molecule to substantially be trapped between contacting free ends 206. By substantially trapping an analyte molecule to be tested between the free ends 206, SERS on the analyte molecule may be enhanced because the relatively small gaps between the free ends 206 create “hot spots” having relatively large electric field strengths. Substantially trapping an analyte molecule here is intended to indicate that the analyte molecule may either be trapped between two free ends 206 or may be attached on one of the free ends 206 of adjacently located free ends 206.

According to an example, the apparatus 100, 150 is integrated onto a single chip, for instance, as an integrated electrical circuit (IC). That is, the optical waveguide 102, the wavelength selective devices 120a-120n, the detectors 130, and the illumination source 140 are all integrated onto a single chip. The integrated chip may be in communication with a processor (not shown) that is to at least one of output, for instance, display, and identify the frequencies and wavelengths of light detected by the detectors 130. The processor may be integrated onto the chip or may be external to the chip. The processor may be integrated onto the chip or may be provided on an external device.

In addition, or alternatively, the optical waveguide 102 may be removable, such that, the apparatus 100, 150 may be used to test different samples simply by replacing the optical waveguide 102 and introducing a different fluid sample into the new optical waveguide 102. The optical waveguide 102 may also be fixed and thus may be cleaned out prior to introduction of a different fluid sample into the optical waveguide 102.

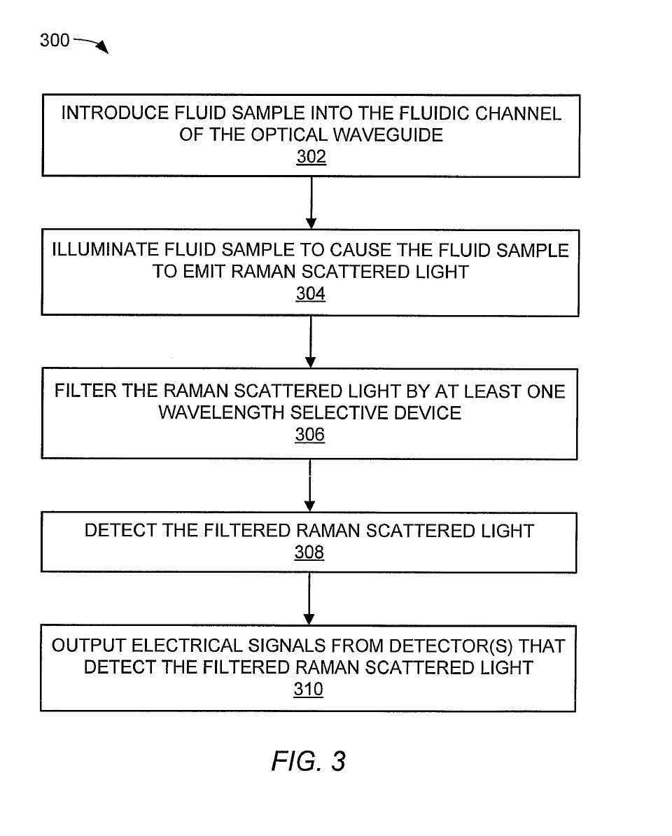

Turning now to FIG. 3, there is shown a flow diagram of a method 300 for performing spectroscopy, according to an example. It should be understood that the method 300 depicted in FIG. 3 may include additional processes and that some of the processes described herein may be removed and/or modified without departing from a scope of the method 300. In addition, although particular reference is made herein to the apparatus 100, 150 in implementing the method 300, it should be understood that the method 300 may be implemented through use of a differently configured apparatus without departing from a scope of the method 300.

At block 302, a fluid sample is introduced into the fluidic channel 104 of the optical waveguide 102. The fluid sample may be introduced through an opening in the fluidic channel 104 either prior to or after the optical waveguide 102 is positioned to receive excitation light 142 from the illumination source 140.

At block 304, the fluid sample contained in the fluid channel 104 is illuminated to cause molecules of the fluid sample to emit Raman scattered light. The Raman scattered light is shifted in frequency by an amount that is characteristic of particular vibrational modes of the molecules. According to an example, the emission of the Raman scattered light from the molecules is enhanced by the nano-fingers 152 and, more particularly, the Raman-active nano-particles 210 discussed above with respect to FIGS. 1C, 2A and 2B. More particularly, the excitation light 142 illuminates the free ends 206 of the nano-fingers 152, and more particularly, the Raman-active nano-particles 210 provided at the free ends 206, thereby causing hot spots of relatively large electric field strength. These hot spots are increased at the locations where the free ends 206 of multiple nano-fingers 152 contact each other. The electric fields generated at the contact locations between the free ends 206 of the nano-fingers 152 generally enhance the rate at which Raman light is scattered by analyte molecules positioned at or near the contact locations.

The Raman active nano-particles 210 located near or adjacent to the analyte molecule(s) generally enhance the production of Raman scattered light from the analyte molecule(s) by concentrating or otherwise enhancing an electromagnetic field in a vicinity of the analyte molecule(s). In examples where the nano-fingers 152 are formed of a metallic material, the nano-fingers 152 themselves may also enhance the production of the Raman scattered light. As also discussed above, the contacting of two or more of the free ends 206 with each other to trap the analyte molecule(s) may substantially increase the likelihood that the analyte molecule(s) will be positioned near or in contact with some Raman active nano-particles 210 and thus be positioned within a hot spot. In this regard, the likelihood that an analyte molecule(s) will produce sufficiently strong Raman scattered light to be detected by at least one of the detectors 130 will thus also be increased.

Thus, according to an example, following introduction of the fluid sample into the fluidic channel 104 and prior to illumination of the fluid sample at block 304, the nano-fingers 152 are caused to collapse upon each other. Thus, for instance, the fluid sample may be introduced into the fluidic channel 104 while the nano-fingers 152 are arranged, for instance, as shown in FIG. 2A. In addition, the nano-fingers 152 may be caused to collapse upon each other, for instance, as shown in FIG. 2B, in any of the manners discussed above.

In any regard, the optical waveguide 102 channels the Raman scattered light emitted from the molecules of the fluid sample to the wavelength selective devices 120a-120n.

At block 306, the wavelength selective devices 120a-120n filter the Raman scattered light. As discussed above, each of the wavelength selective devices 120a-120n comprises a predetermined bandwidth and is to capture frequencies of light within the predetermined bandwidth. Thus, each of wavelength selective devices 120a-120n generally operates to allow light having the frequencies and wavelengths that are within the respective predetermined bandwidths to pass therethrough, effectively filtering the light propagating through the optical waveguide 102 from reaching the detectors 130.

At block 308, at least one of the detectors 130 detects the filtered Raman scattered light. More particularly, the detectors 130 coupled to the wavelength selective devices 120a-120n through which the light has propagated through the wavelength selective devices 120a-120n detect the filtered Raman scattered light propagating through the optical waveguide 102 having predetermined frequencies and wavelengths.

At block 310, the detector(s) 130 that detect the filtered Raman scattered light output electrical signal(s). The detector(s) 130 may output the electrical signal(s) to a processor (not shown) that is to determine the set of frequencies that have been detected by the detector(s) 130. In other words, the processor may be provided with information regarding the predetermined bandwidths of the wavelength selective devices 120a-120n to which the detectors 130 are respectively coupled. In addition, the processor may determine which of the detectors 130 outputted the electrical signals and may use that information to determine at least some of the frequencies of the light emitted from the molecules of the fluid sample.

According to an example, wavelength selective devices 120a-120n having predetermined bandwidths are selected for implementation of the method 300. In this example, for instance, the predetermined bandwidths of the wavelength selective devices 120a-120n may be selected to identify a particular type of molecule. Thus, for instance, the particular type of molecule may be determined to be present in a fluid sample if each of the detectors 130 coupled to the wavelength selective devices 120a-120n outputs electrical signals at block 310.

According to another example, a relatively large number of wavelength selective devices 120a-120n covering a relatively wide range of bandwidths are selected for implementation of the method 300. In this example, the types of molecule(s) in a fluid sample may be determined from a determination of which of the detectors 130 coupled to the wavelength selective devices 120a-120n outputted electrical signals at block 310.

According to a further example, a number of tunable wavelength selective devices 120a-120n, which may include a single tunable wavelength selective device 120a, is selected for implementation of the method 300. In this example, the wavelength selective devices 120a-120n are tuned to different bandwidths during different iterations of the method 300. In addition, a determination is made as to which bandwidths resulted in the detector(s) 130 coupled to the tunable wavelength selective device(s) 120a-120n outputting electrical signal(s) at block 310.

Although described specifically throughout the entirety of the instant disclosure, representative examples of the present disclosure have utility over a wide range of applications, and the above discussion is not intended and should not be construed to be limiting, but is offered as an illustrative discussion of aspects of the disclosure.

What has been described and illustrated herein is an example along with some of its variations. The terms, descriptions and figures used herein are set forth by way of illustration only and are not meant as limitations. Many variations are possible within the spirit and scope of the subject matter, which is intended to be defined by the following claims—and their equivalents—in which all terms are meant in their broadest reasonable sense unless otherwise indicated.

What is claimed is:

1. An apparatus for performing spectroscopy comprising:
an optical waveguide comprising a fluidic channel to receive a fluid sample, wherein the optical waveguide is to propagate lightwaves at a set of frequencies;
a wavelength selective device coupled to the optical waveguide, wherein the wavelength selective device comprises a predetermined bandwidth and is to capture frequencies of light within the predetermined bandwidth; and
a detector coupled to the wavelength selective device to generate signals that identify the frequencies captured by the wavelength selective device.

2. The apparatus according to claim 1, wherein the wavelength selective device comprises a ring resonator.

3. The apparatus according to claim 1, wherein the wavelength selective device comprises a distributed Bragg reflector.

4. The apparatus according to claim 1, wherein the wavelength selective device is tunable to different predetermined bandwidths and is to capture frequencies within the different predetermined bandwidths.

5. The apparatus according to claim 1, further comprising:
a plurality of wavelength selective devices coupled to the optical waveguide, wherein each of the plurality of wavelength selective devices comprises one of a plurality of predetermined bandwidths of a predefined molecule.

6. The apparatus according to claim 1, further comprising:
an illumination source for illuminating a sample contained in the fluidic channel.

7. The apparatus according to claim 6, wherein the optical waveguide, the wavelength selective device, the detector and the illumination source are integrated onto a single chip.

8. The apparatus according to claim 1, further comprising:
a plurality of nano-fingers positioned within the fluidic channel of the optical waveguide, said plurality of nano-fingers having free ends.

9. The apparatus according to claim 8, further comprising:
Raman-active material nano-particles attached to the free ends of the nano-fingers.

10. The apparatus according to claim 8, wherein the nano-fingers are composed of a flexible material.

11. A method for performing spectroscopy comprising:
a) illuminating an optical waveguide comprising a fluidic channel, wherein a fluid sample is contained in the fluidic channel, wherein the fluid sample is to emit Raman scattered light having a frequency responsive to becoming illuminated and wherein the Raman scattered emitted from the fluid sample is to propagate through the optical waveguide;
b) filtering the Raman scattered light in a wavelength selective device coupled to the optical waveguide, wherein the wavelength selective device comprises a predetermined bandwidth and is to capture frequencies of light within the predetermined bandwidth;
c) detecting frequencies of light that have propagated through the wavelength selective device in the detector; and
d) outputting electrical signals by the detector responsive to detecting the frequencies of light.

12. The method according to claim 11, wherein the wavelength selective device is tunable to different predetermined bandwidths and is to capture frequencies within the different predetermined bandwidths, said method further comprising:
tuning the wavelength selective device to a different predetermined wavelength and repeating a)-d).

13. The method according to claim 11, wherein a plurality of nano-fingers having free ends are positioned within the fluidic channel of the optical waveguide and wherein Raman-active nano-particles are attached to the free ends of the nano-fingers, said method further comprising:
introducing the fluid sample into the fluidic channel such that the fluid sample contacts the Raman-active nano-particles prior to a).

14. The method according to claim 13, further comprising:
collapsing the nano-fingers to cause the free ends to substantially contact each other prior to a).

15. An integrated sensing apparatus comprising:
a chip;
an optical waveguide attached to the chip, said optical waveguide comprising a fluidic channel to receive a fluid sample, wherein the optical waveguide is to propagate lightwaves at a set of frequencies;
a wavelength selective device coupled to the optical waveguide, wherein the wavelength selective device comprises a predetermined bandwidth and is to capture frequencies of light within the predetermined bandwidth;
a detector coupled to the wavelength selective device to generate signals that identify the frequencies captured by the wavelength selective device; and
an illumination source attached to the chip, said illumination source to illuminate a sample contained in the fluidic channel.
